(19) United States
(12) Patent Application Publication
(10) Pub. No.: US 2011/0250476 A1
(43) Pub. Date: Oct. 13, 2011

(54) BATTERY PACKS

(75) Inventor: Hideyuki TAGA, Anjo-shi (JP)

(73) Assignee: MAKITA CORPORATION, Anjo-shi (JP)

(21) Appl. No.: 13/083,005

(22) Filed: Apr. 8, 2011

(30) Foreign Application Priority Data
Apr. 13, 2010 (JP) 2010-092109

(51) Int. Cl. H01M 2/00; H01M 2/30; H01M 2/02

(52) U.S. Cl. 429/7

(57) ABSTRACT

A battery pack includes a battery case, a cell assembly including a plurality of battery cells accommodated in the battery case, a circuit board disposed within the battery case, and a plurality of lead members electrically connecting between the circuit board and the battery cells. The lead members extend across at least one space positioned between the circuit board and the battery cells.

This application claims priority to Japanese patent application serial number 2010-92109, the contents of which are incorporated herein by reference.

### BACKGROUND OF THE INVENTION

1. Field of the Invention

The present invention relates to battery packs and, in particular, to battery packs usable mainly for electric tools.

2. Description of the Related Art

A known battery pack is shown in FIG. 7 in a perspective view, partly in section. Referring to FIG. 7, a battery pack 100 is equipped with a battery case 102, a cell assembly 104, a circuit board 106, and lead plates 108, 109, and 110. The cell assembly 104 is accommodated in the battery case 102. Further, the cell assembly 104 is equipped with a plurality of (five, in FIG. 7) battery cells 112 parallel to each other, and a cell holder 114 holding the plurality of battery cells 112. The circuit board 106 is accommodated in the battery case 102 so as to be on the upper side of the cell assembly 104 and adjacent to the cell assembly 104 while being parallel thereto. The lead plates 108, 109, and 110 respectively have cell side terminal portions 108a, 109a, and 110a electrically connected to the battery cell 112, board side terminal portions 108b, 109b, and 110b electrically connected to the circuit board 106, and connecting portions 108c, 109c, and 110c establishing contact between the cell side terminal portions 108a, 109a, and 110a and the board side terminal portions 108b, 109b, and 110b. The connecting portions 108c, 109c, and 110c are formed as strips extending parallel to the battery cell 112. Further, the connecting portions 108c, 109c, and 110c are arranged between the circuit board 106 and the battery cell 112 adjacent to the circuit board 106 so as to be parallel to the circuit board 106. A description of lead plates (not shown) at the opposite end surface of the battery cell 112 will be omitted.

In a battery pack disclosed in Japanese Laid-Open Patent Publication No. 2001-143677, lead plates are arranged between a cell assembly and a circuit board so as to be parallel to the circuit board.

In the case of the above known battery pack 100 (see FIG. 7), the connecting portions 108c, 109c, and 110c of the lead plates 108, 109, and 110 are arranged between the cell assembly 104 and the circuit board 106. Thus, it is necessary to set between the cell assembly 104 and the circuit board 106 the requisite space for arranging the connecting portions 108c, 109c, and 110c of the lead plates 108, 109, and 110. This leads to increase in the size of the battery pack 100 (especially in the height direction in FIG. 7). Also in the case of the battery pack of Japanese Laid-Open Patent Publication No. 2001-143677, it is necessary to set between the cell assembly and the circuit board the requisite space for arranging the lead plates, resulting in the same problem as that in the above-described conventional example.

Therefore, there is a need in the art for reducing the size of a battery pack.

### SUMMARY OF THE INVENTION

A battery pack includes a battery case, a cell assembly including a plurality of battery cells accommodated in the battery case, a circuit board disposed within the battery case, and a plurality of lead members electrically connecting between the circuit board and the battery cells. The lead members extend across spaces positioned between the circuit board and the battery cells.

### BRIEF DESCRIPTION OF THE DRAWINGS

FIG. 1 is a perspective view of a battery pack according to an example;

FIG. 2 is a perspective view of the battery pack with a cover member of a battery case open;

FIG. 3 is a perspective view, partly in section to show lead plates, of the battery pack with the cover member of the battery case open;

FIG. 4 is a perspective view, partly in section to show a cell assembly, of the battery pack with the cover member of the battery case open;

FIG. 5 is a perspective view illustrating how battery cells are arranged in the battery pack;

FIG. 6 is a schematic view illustrating a circuit of the battery pack; and

FIG. 7 is a perspective view, partly in section, of a known battery pack.

### DETAILED DESCRIPTION OF THE INVENTION

Each of the additional features and teachings disclosed above and below may be utilized separately or in conjunction with other features and teachings to provide improved battery packs. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful examples of the present teachings. Various examples will now be described with reference to the drawings.

In one example, a battery pack includes a battery case, a cell assembly including a plurality of battery cells accommodated in the battery case and parallel to each other, a circuit board disposed within the battery case and adjacent to the cell assembly, and a plurality of lead members. Each of the lead members has a cell side terminal portion electrically connected to at least one of the battery cells, a board side terminal portion electrically connected to the circuit board, and a connecting portion connecting between the cell side terminal portion and the board side terminal portion. The connecting portion of each of the lead members is disposed within a space positioned between the battery cells and adjacent to the circuit board.

Therefore, it is not necessary to provide a space for arranging the connecting portions of the lead members set between the cell assembly and the circuit board as in the known example (see FIG. 7). Accordingly, it is possible to arrange the cell assembly and the circuit board close to each other, whereby it is possible to reduce the size of the battery pack. The lead member may be a lead plate, lead wire or the like. The space may include a plurality of spaces each positioned between two of three or more battery cells arranged along a direction parallel to the circuit board.

In the case that each of the lead members is a lead plate, the connecting portion of each of the lead members may be formed as a strip extending along and parallel to the battery cells and having a width oriented in a direction crossing the circuit board. With this arrangement, it is possible to provide a compact arrangement of the connecting portions with respect to a direction parallel to the circuit board while ensuring the requisite plate width for the connecting portions of the lead members.

The cell assembly may further include a cell holder holding the plurality of battery cells. The cell holder may define the space and two or more of the connecting portions of the lead members may be disposed within the same space. The cell holder may have at least one partition member separating the two or more connecting portions from each other. Thus, it is possible to prevent, for example, short-circuiting between the connecting portions, when the lead members are lead plates, and entanglement of the connecting portions, when the lead members are lead wires.

A battery pack according to an example will now be described. For the sake of convenience, forward, rearward, rightward, leftward, upward, and downward directions with respect to the battery pack are determined as indicated by arrows in FIGS. 1 through 5.

First, a general construction of a battery pack 10 of this example will be described. The battery pack 10 of this example is used, for example, in a hand-held electric tool (not shown) such as an electric screwdriver or an electric drill; it allows repeated use through recharging by a charger (not shown). The battery pack 10 can be mounted to the electric tool and the charger through forward sliding; conversely, it can be detached therefrom through rearward sliding.

As shown in FIG. 1, the battery pack 10 is equipped with a box-like battery case 12 elongated in the forward and rearward directions. The battery case 12 may be made of resin and includes a bottomed box-like case main body 13 whose upper side is open and a cover member 14 covering the upper side opening of the case main body 13. A mounting portion 15 for mounting to the electric tool and the charger is provided on the upper surface side of the cover member 14. The mounting portion 15 has a pair of right and left guide rails 16 extending in the forward and rearward directions. On the inner sides of the guide rails 16, there are formed charge/discharge slits 17 having upper and front openings. On the inner side (right-hand side) of the left-hand side slit 17, there is formed a temperature detection slit 18 having upper and front openings and used for detecting the temperature. Between the temperature detection slit groove 18 and the right-hand side slit 17, there is formed a connector opening 19 that is upwardly open.

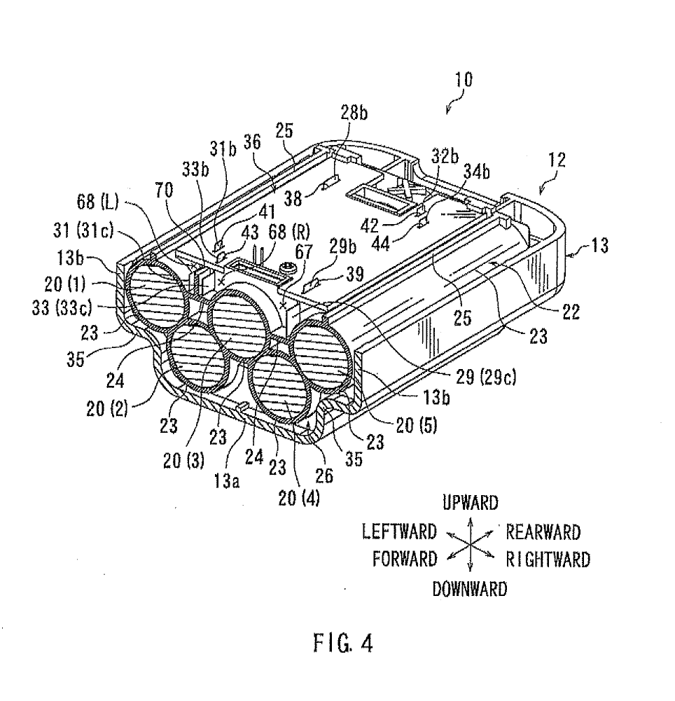

As shown in FIG. 4, inside the ease main body 13, there are accommodated a plurality of (five, in this example) battery cells 20 arranged parallel to each other and held by a cell holder 22. As the battery cells 20, cylindrical battery cells are employed. The cell holder 22 is made of resin and is held in position within the case main body 13 through fitting engagement therewith. The cell holder 22 holds the five battery cells 20 tiered in a staggered fashion and includes five cylindrical accommodation tube portions 23 capable of individually accommodating the battery cells 20 in a staggered fashion. That is, there are five accommodation tube portions 23 in total (three on the upper stage and two on the lower stage), with the accommodation tube portions 23 vertically adjacent to each other being connected together. Between the accommodation tube portions 23 on the upper stage horizontally adjacent to each other, there are provided horizontal connection plate portions 24 extending in the forward and rearward direction. The battery cells 20 are respectively inserted into and held by the accommodation tube portions 23. As a result, the battery cells 20 are arranged so as to be parallel to each other. Further, the five battery cells 20 and the cell holder 22 constitute a cell assembly 26.

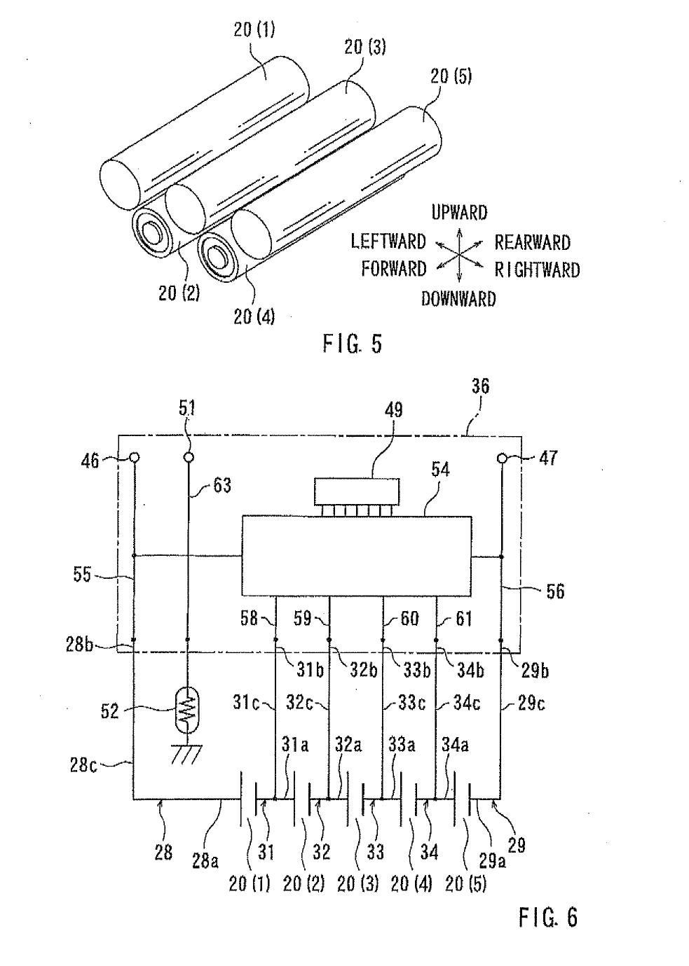

In the present specification, the term “staggered and tiered fashion” means a way in which the battery cells 20 on the lower stage (or the upper stage) are arranged to enter the valley portions between the adjacent battery cells 20 on the upper stage (or the lower stage) so that the resultant heap may not collapse (see FIG. 5). For the sake of convenience in illustration, the upper left-hand side battery cell 20 will be referred to as a first battery cell 20(1), the lower left-hand side battery cell 20 will be referred to as a second battery cell 20(2), the upper central battery cell 20 will be referred to as a third battery cell 20(3), the lower right-hand side battery cell 20 will be referred to as a fourth battery cell 20(4), and the upper right-hand side battery cell 20 will be referred to as a fifth battery cell 20(5).

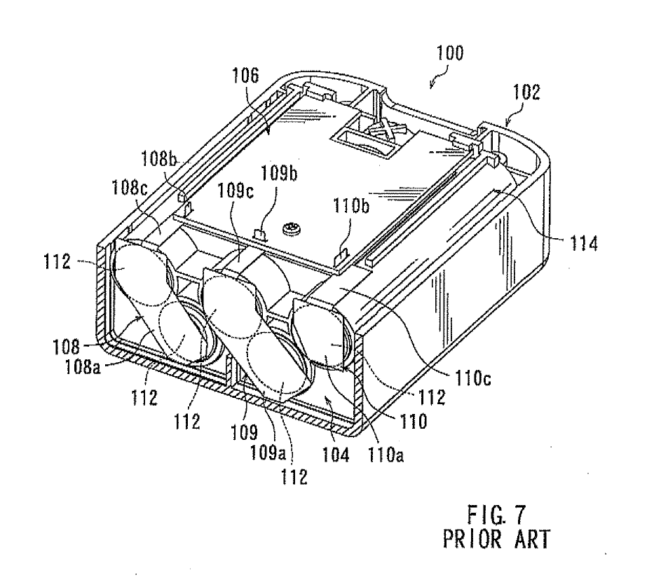

As shown in FIG. 5, positive side electrodes of the first battery cell 20(1), the third battery cell 20(3), and the fifth battery cell 20(5) are directed rearwards, and negative side electrodes thereof are directed forwards. Positive side electrodes of the second battery cell 20(2) and the fourth battery cell 20(4) are directed forwards, and negative side electrodes thereof are directed rearwards. The battery cells 20(1) through 20(5) are connected in series via lead plates 28, 29, and 31 through 34 (described below) (see FIG. 6).

As shown in FIG. 4, at corner portions formed between a bottom wall portion 13a and right and left-hand side wall portions 13b of the case main body 13 of the battery case 12, there are formed inwardly oriented concave portions 35. In this example, the left-hand side concave portion 35 is formed as a stepped portion so as to enter the valley portion between the first battery cell 20(1) and the second battery cell 20(2). The right-hand side concave portion 35 is formed as a stepped portion so as to fill the valley portion between the fourth battery cell 20(4) and the fifth battery cell 20(5). In this way, the inwardly oriented concave portions 35 are formed at the corner portions defined by the bottom wall portion 13a and the side wall portions 13b of the case main body 13 of the battery case 12, whereby it is possible to reduce the width (the size in the right and left direction) of the bottom portion of the battery case 12, and to reduce the size of the battery pack 10. Instead of the stepped portions, the concave portions 35 may be formed as inclined plate-like portions, recessed arcuate-plate-like portions or the like.

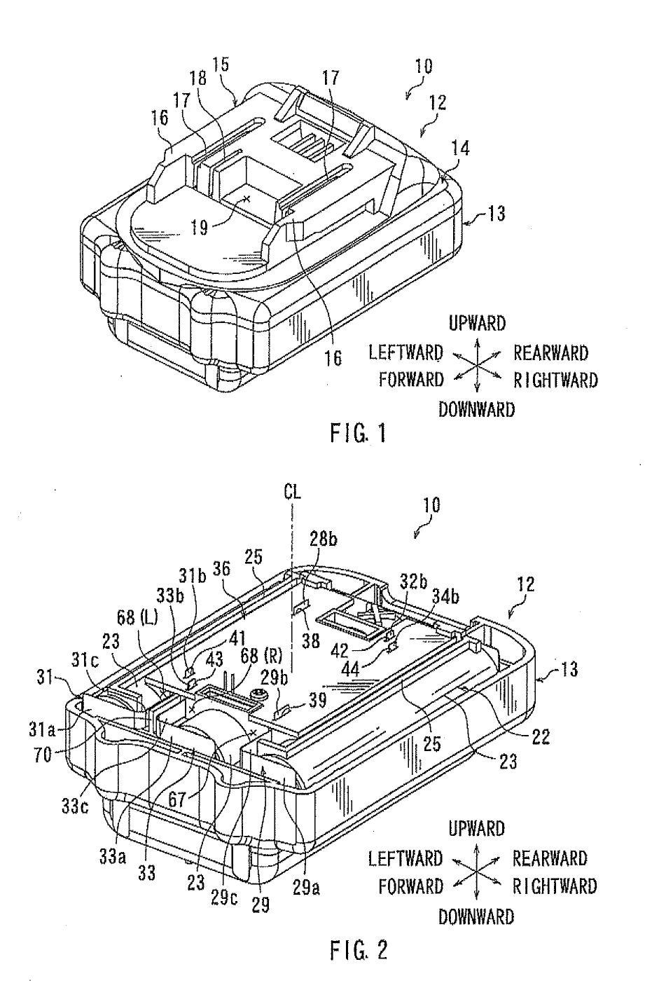

As shown in FIG. 2, rectangular circuit board 36 elongated in the forward and rearward direction is arranged horizontally on the cell holder 22. As a result, the circuit board 36 is accommodated in the battery case 12 in a state that it is on the upper side of the cell assembly 26 and adjacent to the cell assembly 26 so as to be parallel thereto. The cell holder 22 has U-shaped right and left retainer frame portions 25 positioned symmetrically with each other in the right and left direction and surrounding the right and left side end portions of the circuit board 36.

As shown in FIG. 2, the circuit board 36 has terminal connection holes 38, 39, and 41 through 44. More specifically, positive terminal connection hole 38 is formed in the left-hand side rear end portion of the circuit hoard 36. The negative terminal connection hole 39 is formed in the right-hand side front end portion of the circuit board 36. The first terminal connection hole 41 and the third terminal connection hole 43 are formed in the left-hand side front end portion of the circuit board 36. The third terminal connection hole 43 is arranged obliquely on the right-hand front side of and adjacent to the first terminal connection hole 41. The second terminal connection hole 42 and the fourth terminal connection hole 44 are formed in the right-hand side rear end portion of the circuit board 36. The fourth terminal connection hole 44 is arranged obliquely on the left-hand rear side of and adjacent to the second terminal connection hole 42.

The terminal connection holes 38, 39, and 41 through 44 are formed as slits elongated in the forward and rearward direction. The length in the forward and rearward direction of the positive terminal connection hole 38 and of the negative terminal connection hole 39 is set to be larger than the length in the forward and rearward direction of the first through fourth terminal connection holes 41 through 44. The positive terminal connection hole 38 and the negative terminal connection hole 39 are arranged in point symmetry with respect a center line CL of the cell assembly 26. The first terminal connection hole 41 and the fourth terminal connection hole 44 are arranged in point symmetry with respect to the center line CL of the cell assembly 26. The third terminal connection hole 43 and the second terminal connection hole 42 are arranged in point symmetry with respect to the center line CL of the cell assembly 26.

Right and left charge/discharge terminals 46 and 47 (see FIG. 6) are provided on the circuit board 36. For example, the left charge/discharge terminal 46 is formed as the positive side charge/discharge terminal 46, and the right charge/discharge terminal 47 is formed as the negative side charge/discharge terminal 47. In FIGS. 2 through 4, which show the circuit board 36, the charge/discharge terminals 46 and 47, and a connector 49, a temperature detection terminal 51, a control circuit 54, etc. (See FIG. 6), which are provided on the circuit board 36, are omitted.

The charge/discharge terminals 46 and 47 are arranged on the circuit board 36 so as to be in correspondence with slits 17 (See FIG. 1) of the cover member 14. Thus, through mounting the battery pack 10 to the electric tool or the charger, positive side connection terminals and negative side connection terminals (not shown) of the electric tool or the charger are connected to the charge/discharge terminals 46 and 47 via the slits 17. As shown in FIG. 6, the positive side charge/discharge terminal 46 is connected to the positive side lead plate 28 via the circuit board 36 (more specifically, a wiring portion 55). Further, the negative side charge/discharge terminal 47 is connected to the negative side lead plate 29 via the circuit board 36 (more specifically, a wiring portion 56).

A block-like connector 49 is provided on the circuit board 36 (see FIG. 6). The connector 49 is arranged between the charge/discharge terminals 46 and 47. Although not shown, the connector 49 is fit-engaged with the opening 19 (See FIG. 1) of the cover member 14, whereby the front surface thereof, which is the external connection side surface, is forwardly exposed. Thus, through mounting the battery pack 10 to the electric tool or the charger, the external connectors (not shown) of the electric tool or of the charger are connected to the connector 49.

The temperature detection terminal 51 is provided on the circuit board 36 (See FIG. 6). The temperature detection terminal 51 is arranged on the circuit board 36 so as to be in correspondence with the slit 18 (see FIG. 1) of the cover member 14. Thus, through mounting the battery pack 10 to the electric tool or the charger, temperature input terminals (not shown) of the electric tool or of the charger are connected to the temperature detection terminal 51 via the slit 18. Further, as shown in FIG. 6, one end portion of a temperature-sensing element 52 configured to detect the temperature of the battery cells 20 is connected to ₜhe temperature detection terminal 51 via the circuit board 36 (more specifically, a wiring portion 63). The other end portion of the temperature-sensing element 52 is grounded. As the temperature-sensing element 52, there is used, for example, a thermistor configured to undergo a change in resistance value according to temperature.

The control circuit 54 is provided on the circuit board 36 (see FIG. 6). The control circuit 54 is a circuit mainly for monitoring the charge/discharge condition of the battery cells 20. Although not shown, a circuit element (not shown) related to the control circuit 54 is mounted on the circuit board 36, and the connector 49 is electrically connected to the control circuit 54.

As shown in FIG. 6, the circuit board 36 has the positive side charge/discharge terminal 46 and the positive side wiring portion 55 electrically connecting the control circuit 54 and the positive side lead plate 28. The connection end of the wiring portion 55 is connected to the positive terminal connection hole 38 (see FIG. 2) of the circuit board 36. Further, the circuit board 36 has the negative side charge/discharge terminal 47 and the negative side wiring portion 56 electrically connecting the control circuit 54 and the negative side lead plate 29. The connection end of the wiring portion 56 is connected to the positive terminal connection hole 39 (see FIG. 2) of the circuit board 36. Further, the circuit board 36 has first through fourth wiring portions 58 through 61 electrically connecting the control circuit 54 and the first through fourth lead plates 31 through 34. The connection ends of these wiring portions 58 through 61 are respectively connected to the first through fourth terminal connection holes 41 through 44 (see FIG. 2). Further, the circuit board 36 has a temperature detection wiring portion 63 electrically connecting the temperature detection terminal 51 and the temperature-sensing element 52.

Next, the construction of the lead plates 28, 29, and 31 through 34, will be described. The lead plates 28, 29, and 31 through 34 are formed by performing stamping, bending, etc. on a conductive metal material. The lead plates 28, 29, and 31 through 34 serve as lead members. The lead plates 29, 31, and 33 are arranged on the front side of the cell assembly 26, and the lead plates 28, 33, and 34 are arranged on the rear side of the cell assembly 26.

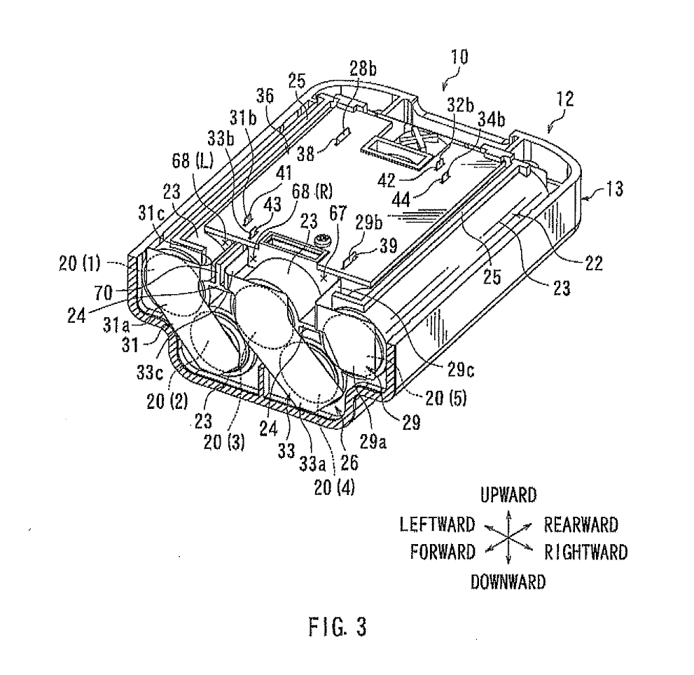

First, the negative side lead plate 29, which is arranged on the front side of fifth battery cell 20(5) of the cell assembly 26 as shown in FIG. 3, will be described. The negative side lead plate 29 has a cell side terminal portion 29a, a board side terminal portion 29b, and a connecting portion 29c. The cell side terminal portion 29a is formed as a flat plate facing in the forward and rearward direction. The terminal portion 29a is electrically connected to the negative side electrode of the fifth battery cell 20(5). The connecting portion 29c is formed as a strip extending straight rearwards from the left-hand side edge of the upper end portion of the cell side terminal portion 29a. The width direction of the connecting portion 29c is oriented in the vertical direction, that is, the upward/downward direction.

The connecting portion 29c of the negative side load plate 29 is arranged by utilizing a right-hand side space 67 defined between the third battery cell 20(3) and the fifth battery cell 20(5) that are adjacent to the circuit board 36 (see FIG. 4). More specifically, the connecting portion 29c is arranged between the right-hand side accommodation tube portion 23 and the central accommodation tube portion 23 adjacent to each other in the upper stage of the cell holder 22 and in the right-hand side space 67 on the right-hand side connection plate portion 24 extending therebetween.

At the rear end portion of the connecting portion 29c of the negative side lead plate 29, the board side terminal portion 29b protrudes upwardly as a protrusion. The connecting portion 29c connects between the cell side terminal portion 29a and the board side terminal portion 29b. The board side terminal portion 29b is formed so as to be flush with the connecting portion 29c, with the width direction thereof being oriented in the forward and rearward direction. The terminal portion 29b is inserted from below into the negative terminal connection hole 39 of the circuit board 36 (see FIG. 3). The terminal portion 29b is electrically connected to the negative side wiring portion 56 of the circuit board 36 by soldering (see FIG. 6).

The positive side lead plate arranged on the rear side of the first battery cell 20(1) of the cell assembly 26 is of the same construction as the negative side lead plate 29, and is arranged in point symmetry with respect to the negative side lead plate 29, with the center line CL (See FIG. 2) of the cell assembly 26 being at the center, so that a detailed description thereof will be omitted. The positive side lead plate 28 has a cell side terminal portion 28a, a board side terminal portion 28b, and a connecting portion 28c respectively corresponding to the cell side terminal portion 29a, the board side terminal portion 29b, and the connecting portion 29c of the negative side lead plate 29 (see FIG. 6). The cell side terminal portion 28a is electrically connected to the positive side electrode of the first battery cell 20(1). The board side terminal portion 28b is inserted from below into the positive terminal connection hole 38 of the circuit board 36 (see FIG. 3). The terminal portion 28b is electrically connected to the positive side wiring portion 55 of the circuit board 36 (see FIG. 6).

Next, the first lead plate 31, which is arranged on the front side of the first battery cell 20(1) and the second battery cell 20(2) of the cell assembly 26 as shown in FIG. 3, will be described. The first lead plate 31 has a cell side terminal portion 31a, a board side terminal portion 31b, and a connecting portion 31c. The cell side terminal portion 31a is formed as a thin and narrow flat plate facing in the forward and rearward direction. The terminal portion 31a is electrically connected to the negative side electrode of the first battery cell 20(1) and the positive side electrode of the second battery cell 20(2), with the two battery cells 20(1) and 20(2) being connected in series. The connecting portion 31c is formed as a strip extending straight rearwards from the right-hand side edge of the upper end portion of the cell side terminal portion 31a. The width direction of the connecting portion 31c is oriented in the vertical direction, that is, the upward/downward direction.

The connecting portion 31c of the first lead plate 31 is arranged by utilizing a left-hand side space 68 defined between the first battery cell 20(1) and the third battery cell 20(3) that are adjacent to the circuit board 36 (see FIG. 4). More specifically, the connecting portion 31c is arranged between the left-hand side accommodation tithe portion 23 and the central accommodation tube portion 23, which are adjacent to each other in the upper stage of the cell holder 22, and in the left-hand side portion of the left-hand side space 68 on the left-hand side connection plate portion 24 extending therebetween. In this example, a partition wall 70 dividing the left-hand side space 68 into right and left portions is formed on the left-hand side connection plate portion 24. Thus, the connecting portion 31c is arranged in the left-hand side portion (indicated by symbol (L)) of the left-hand side space 68. The partition wall 70 may be called a partitioning member.

At the rear end portion of the connecting portion 31c of the first lead plate 31, the board side terminal portion 31b protrudes upwardly as a protrusion. The connecting portion 31c connects between the cell side terminal portion 31a and the board side terminal portion 31b. The board side terminal portion 31b is formed so as to be flush with the connecting portion 31c, with the width direction thereof being oriented in the forward and rearward direction. The terminal portion 31b is inserted from below into the first terminal connection hole 41 of the circuit board 36 (see FIG. 3). The terminal portion 31b is electrically connected to the first wiring portion 58 of the circuit board 36 by soldering (see FIG. 6). The board side terminal portion 31b and the connecting portion 31c of the first lead plate 31 serve to take the intermediate voltage between the first battery cell 20(1) and the second battery cell 20(2) to the first wiring portion 58 of the circuit board 36.

The fourth lead plate 34 arranged on the rear side of the fourth battery cell 20(4) and the fifth battery cell 20(5) of the cell assembly 26 is of the same construction as the first lead plate 31, and is arranged in point symmetry with respect to the first lead plate 31, with the center line CL (See FIG. 2) of the cell assembly 26 being at the center, so that a detailed description thereof will be omitted. The fourth lead plate 34 has a cell side terminal portion 34a, a board side terminal portion 34b, and a connecting portion 34c respectively corresponding to the cell side terminal portion 31a, the board side terminal portion 31b, and the connecting portion 31c of the first lead plate 31 (see FIG. 6). The cell side terminal portion 34a is electrically connected to the negative side electrode of the fourth battery cell 20(4) and the positive side electrode of the battery cell 20(5), with the two battery cells 20(4) and 20(5) being connected in series. The board side terminal portion 34b is inserted from below into the fourth terminal connection hole 44 of the circuit board 36 (see FIG. 3). The terminal portion 34b is electrically connected to the fourth wiring portion 61 of the circuit board 36 (see FIG. 6). The board side terminal portion 34b and the connecting portion 34c of the fourth lead plate 34 serve to take the intermediate voltage between the two battery cells 20(4) and 20(5) to the fourth wiring portion 61 of the circuit board 36.

Next, the third lead plate 33, which is arranged on the front side of the third battery cell 20(3) and the fourth battery cell 20(4) of the cell assembly 26 as shown in FIG. 3, will be described. The third lead plate 33 has a cell side terminal portion 33a, a board side terminal portion 33b, and a connecting portion 33c. The cell side terminal portion 33a is formed as a thin and narrow flat plate facing in the forward and rearward direction. The terminal portion 33a is electrically connected to the negative side electrode of the third battery cell 20(3) and the positive side electrode of the fourth battery cell 20(4), with the two battery cells 20(3) and 20(4) being connected in series. The connecting portion 33c is formed as a strip extending straight rearwards from the left-hand side edge of the upper end portion of the cell side terminal portion 33a. The width direction of the connecting portion 33c is oriented in the vertical direction, that is, the upward/downward direction.

The connecting portion 33c of the third lead plate 33c is arranged by utilizing the left-hand side space 68 defined between the first battery cell 20(1) and the third battery cell 20(3) that are adjacent to the circuit board 36 (see FIG. 4). More specifically, the connecting portion 33c is arranged in the right-hand side portion (indicated by symbol (R)) of the left-hand side space 68. As a result, the connecting portion 33c is arranged parallel to the connecting portion 31c of the first lead plate 31 while separated therefrom by the partition wall 70.

At the rear end portion of the connecting portion 33c of the third lead plate 33, the board side terminal portion 33b protrudes upwardly as a protrusion. The connecting portion 33c connects between the cell side terminal portion 33a and the board side terminal portion 33b. The board side terminal portion 33b is formed so as to be flush with the connecting portion 33c, with the width direction thereof being oriented in the forward and rearward direction. The terminal portion 33b is inserted from below into the third terminal connection hole 43 of the circuit board 36 (see FIG. 3). The terminal portion 33b is electrically connected to the third wiring portion 60 of the circuit board 36 by soldering (see FIG. 6). The board side terminal portion 33b and the connecting portion 33c of the third lead plate 33 serve to take the intermediate voltage between the third battery cell 20(3) and the fourth battery cell 20(4) to the third wiring portion 60 of the circuit board 36.

The second lead plate 32, which is arranged on the rear side of the second battery cell 20(2) and the third battery cell 20(3) of the cell assembly 26, is of the same constriction as the third lead plate 33, and is arranged in point symmetry with respect to the third lead plate 33, with the center line CL (see FIG. 2) of the cell assembly 26 being at the center, so that a detailed description thereof will be omitted. The second lead plate 32 has a cell side terminal portion 32a, a board side terminal portion 32b, and a connecting portion 32c respectively corresponding to the cell side terminal portion 33a, the board side terminal portion 33b, and the connecting portion 33c of the third lead plate 33 (see FIG. 6). The cell side terminal portion 32a is electrically connected to the negative side electrode of the second battery cell 20(2) and the positive side electrode of the third battery cell 20(3), with the two battery cells 20(2) and 20(3) being connected in series. The board side terminal portion 32b is inserted from below into the second terminal connection hole 42 of the circuit board 36 (see FIG. 3). The terminal portion 32b is electrically connected to the second wiring portion 59 of the circuit board 36 (sec FIG. 6). The board side terminal portion 32b and the connecting portion 32c of the second lead plate 32 serve to take the intermediate voltage between the two battery cells 20(2) and 20(3) to the second wiring portion 59 of the circuit board 36.

The width (the size in the forward and rearward direction) of the board side terminal portions 28b and 29b of the positive side lead plate 28 and of the negative side lead plate 29 is set to correspond to the length in the forward and rearward direction of the terminal connection holes 38 and 39 of the circuit board 36. The width (the size in the forward and rearward direction) of the board side terminal portions 31b through 34b of the first through fourth lead plates 31 through 34 is set to correspond to the length in the forward and rearward direction of the terminal connection holes 41 through 44 of the circuit board 36. The width (the size in the upward and downward direction) of the connecting portions 28c and 29c of the positive side lead plate 28 and of the negative side lead plate 29 is set to be larger than the width (the size in the upward and downward direction) of the connecting portions 31c through 34c of the first through fourth lead plates 31 through 34.

According to the battery pack 10 constructed as described above, the connecting portions 29c, 31c, and 33c of the negative side lead plate 29, the first lead plate 31, and the third lead plate 33, for example, are arranged by utilizing the spaces 67, 68(L), and 68(R) formed between the battery cells 20 adjacent to the circuit board 36 (see FIG. 3). Thus, it is possible to omit the requisite space for arranging the connecting portions 108c, 109c, and 110c of the lead plates 108, 109, and 110, which has been set between the cell assembly 104 and the circuit board 106 in the conventional example (see FIG. 7). As a result, it is possible to arrange the cell assembly 26 and the circuit board 36 close to each other, thereby achieving a reduction in the size (especially in the height direction) of the battery pack 10.

Further, for example, the connecting portions 29c, 31c, and 33c of the negative side lead plate 29, the first lead plate 31, and the third lead plate 33 are formed as strips extending parallel to the battery cells 20, with their width direction oriented in a direction crossing the circuit board 36. Thus, it is possible to arrange the connecting portion 31c compact with respect to the direction parallel to the circuit board 36 while ensuring the requisite width (the size in the upward and downward direction) for the connecting portion 31c of the lead member.

Further, the cell assembly 26 is equipped with the cell holder 22 holding the five battery cells 20(1) through 20(5), and, in the space 68, there are arranged the connecting portion 31c of the first lead plate 31 and the connecting portion 33c of the third lead plate 33, with the cell holder 22 being provided with the partition wall 70 separating the connecting portions 31c and 33c of the two lead plates 31 and 33 from each other. Thus, it is possible to insulate between the connecting portions 31c and 33c of the two lead plates 31 and 33 by the partition wall 70 of the cell holder 22, thereby preventing short-circuiting between the connecting portions 31c and 33c.

The above example can be modified in various ways. For example, it is only necessary for the plurality of battery cells 20 to be arranged parallel to each other, and the number of battery cells 20, the number of stages thereof, and the way they are tiered (bundled) may be changed as appropriate. Further, at least one of the lead plates 28, 29, and 31 through 34 may be replaced by a lead wire as the lead member. Further, instead of the partition wall 70 of the cell holder 22, it is also possible to provide an insulating material as the partition member between the two connecting portions 31c and 33c. In the case where the lead members consist of lead wires, it is possible to prevent entanglement of the connecting portions by virtue of the partition member. Further, in the case where three or more connecting portions are arranged in one space, it is advisable to provide partition members separating the connecting portions from each other. Further, in the space 68, the partition member may be omitted in the case where there is no risk of short-circuiting between the connecting portions 31c and 33c or of generation of mutual entanglement of the connecting portions of the lead wires in the space 68.

What is claimed is:

1. A battery pack comprising:
a battery case;
a cell assembly including a plurality of battery cells accommodated in the battery case and parallel to each other;
a circuit board disposed within the battery case and adjacent to the cell assembly; and
a plurality of lead members each having a cell side terminal portion electrically connected to at least one of the battery cells, a board side terminal portion electrically connected to the circuit board, and a connecting portion connecting between the cell side terminal portion and the board side terminal portion,
wherein the connecting portion of each of the lead members is disposed within a space positioned between the battery cells and adjacent to the circuit board.

2. The battery pack according to claim 1, wherein the space includes a plurality of spaces each positioned between two of three or more battery cells arranged along a direction parallel to the circuit board.

3. The battery pack according to claim 1, wherein:
the lead members are lead plates; and
the connecting portion of each of the lead plates is formed as a strip extending along and parallel to the battery cells and having a width oriented in a direction crossing the circuit board.

4. The battery pack according to claim 1, wherein:
the cell assembly further includes a cell holder holding the plurality of battery cells; and
the cell holder defines the space.

5. The battery pack according to claim 4, wherein:
two or more of the connecting portions of the lead members are disposed within the same space, and the cell bolder has at least one partition member separating the two or more connecting portions from each other.

6. The battery pack according to claim 5, wherein the at least one partition member is made of an electrical insulation material.

7. The battery pack according to claim 1, wherein
the cell side terminal portion, the connecting portion and the board side terminal portion of each of the lead members extend within a first plane, a second plane and a third plane, respectively;
the first plane and the second plane are perpendicular to each other;
the second plane is parallel to the battery cells; and
the third plane is parallel to the second plane.

8. The battery pack according to claim 7, wherein the second plane and the third plane are the same plane.

9. A battery pack comprising:
a battery case;
a cell assembly including a plurality of battery cells accommodated in the battery case;
a circuit board disposed within the battery case; and
a plurality of lead members electrically connecting between the circuit board and the battery cells and extending across at least one space positioned between the circuit board and the battery cells.

10. The battery pack according to claim 9, further comprising a cell holder holding the cell assembly, wherein the cell holder defines the at least one space.
